(19) United States
(12) Patent Application Publication
(10) Pub. No.: US 2002/0168569 A1
(43) Pub. Date: Nov. 14, 2002

(54) Lithium-ion battery elements manufactured from a microcomposite powder based on a filler and on a fluoropolymer

(75) Inventors: Benoit Barriere, Barc (FR); Philippe Bussi, Bernay (FR)

Correspondence Address: MILLEN, WHITE, ZELANO & BRANIGAN, P.C., 2200 CLARENDON BLVD., SUITE 1400, ARLINGTON, VA, 22201, US

(73) Assignee: ATOFINA, Puteaux (FR)

(21) Appl. No.: 10/100,181

(22) Filed: Mar. 19, 2002

(30) Foreign Application Priority Data
Mar. 19, 2001 (FR) 0103673

(51) Int. Cl. H01M 4/62; H01M 4/66; H01M 2/16; H01M 4/48

(52) U.S. Cl. 429/217; 429/232; 429/252; 429/245; 429/231.1

(57) ABSTRACT

The present invention relates to a lithium-ion battery element which is chosen from the separator and the electroactive layers and which results from the forming of a microcomposite powder comprising a fluoropolymer in the form of particles between 0.1 and 0.5 μm in size and fillers.

The present invention also relates to a lithium-ion battery electrode comprising the above electroactive layer combined with a metal layer.

The present invention also relates to a lithium-ion battery comprising at least one element such as the separator, the electroactive layer or the electrode defined above.

This microcomposite powder can be prepared by coatomization of an aqueous solution containing the fluoropolymer particles between 0.1 and 0.5 μm in size and of an aqueous solution of the fillers. It can also be prepared by flocculation or coagulation of an aqueous solution containing the fluoropolymer particles between 0.1 and 0.5 μm in size and of an aqueous solution of the fillers.

The forming of this microcomposite powder consists in preferably forming a film in order to obtain an electrode film or a separator film. Next, these films are joined together to form a battery. This step (assembly, electrolyte filling, packaging, etc.) is known per se.

### FIELD OF THE INVENTION

The electrodes of a lithium-ion battery consist of an electroactive layer combined with a metal layer (the collector). The electroactive layer is a fluoropolymer highly filled with carbon and/or oxides, the fluoropolymer also being referred to as the binder. This fluoropolymer provides the electroactive layer with cohesion.

In the production of lithium-ion batteries, the electroactive layer containing either lithium metal oxide fillers or carbon and/or graphite fillers, with other ingredients in order to adjust the electrical performance, is in general produced by dispersing the fillers in a solvent in the presence of a fluoropolymer binder. The dispersion thus obtained is, for example, deposited on a metal collector by a casting method, the solvent then being evaporated in order to obtain a negative or positive electrode depending on the fillers used.

The metal collectors used are in general copper foils or grids in the case of the negative electrode and aluminium foils or grids in the case of the positive electrode. The polymer binder provides the electroactive layer with cohesion and ensures that it adheres to the metal collector. This cohesion and adhesion are necessary for correct production of the batteries.

Poor cohesion of the layer means, for example, that the electrodes cannot be wound up or stacked within the multilayer structure of the battery without prejudicial crumbling of the electroactive material. This major drawback also occurs when there is insufficient adhesion to the collector.

The performance of the battery depends intimately on the characteristics of the binder. A good binder makes it possible to produce layers sufficiently filled with electroactive ingredients with respect to the amount of binder necessary and thus makes it possible to have a high specific capacity. The binder must also be stable with respect to oxidation-reduction reactions during charging and discharging cycles and must also be insensitive to the electrolyte present in the battery. This electrolyte typically contains solvents of the carbonate type, such as propylene carbonate, ethylene carbonate and dimethyl ethyl carbonate, and a lithium salt such as LiPF₆ or LiBF₄. By way of example, PVDF or VF₂ copolymers are materials which possess the characteristics for using them as lithium battery binders.

The invention relates to these electroactive layers, the electrodes comprising these electroactive layers and also separators used in these batteries. The lithium-ion battery separators may either be microporous membranes made of a polyolefin or fluoropolymer films filled with powdered silica. The separators of the present invention are of the latter type.

### PRIOR ART

Patent DE 3538732 describes an electrode made from a paste which may possibly be extended and consists of 70 to 80% by weight of carbon powder having a granule size of 30 to 300 μm and of 10 to 20% by weight of a PVDF solution containing 4 to 8% PVDF in DMF (dimethylformamide) and of at least 5% by weight of PTFE powder having a granule size of 10 to 100 μm. The paste is spread out over an aluminium substrate and then dried using an infrared lamp for ½ h to 4 h. This electrode based on PVDF and carbon is permeable to gases and to liquids.

Patent Application JP 52122276 A describes an electrode prepared by depositing, on a porous textile, pyrolysed anisotropic carbon which is itself covered with an aqueous dispersion of TEFLON® (PTFE), and the whole assembly is dried in order to form a hydrophobic porous layer.

U.S. Pat. No. 5,268,239 describes the preparation of a separator plate. This graphite-based plate is a mixture containing from 25 to 75% by weight of graphite and from 25 to 75% by weight of phenolic resin. Next, this plate is pyrolysed between 800 and 1 000° C. and then graphitized between 2 300° C. and 3 000° C. This patent also describes the application of a fluoropolymer film in order to prevent migration of the electrolyte.

Patent Application WO 200024075 describes the preparation of a substrate that can be used for membrane preparation, this substrate comprising a porous fibre matrix, characterized in that the fibres are adhesively bonded to the silica and a fluoropolymer. It also describes the process, with firstly the dispersion of the fibres in water and then secondly the deposition of this dispersion in order to form a network. The network of fibres is then dried and compacted. An aqueous fluoropolymer dispersion can be introduced before or after this drying and compacting step.

Patent FR 2430100 describes a process for preparing a dry finely divided powder characterized in that it consists of particles having a maximum size of approximately 5 μm. This powder comprises precatalysed carbon and a hydrophobic fluorocarbon polymer, for example PTFE. This powder is obtained by flocculating a cosuspension of the precatalysed carbon particles and the polymer particles.

Patent EP 0948071 describes a method for producing an electrode for fuel cells and a catalytic powder prepared by mixing a fine carbon powder supporting a catalytic metal with a colloidal dispersion of a polymer. The suspension thus obtained is dried.

Patent EP 0557259 describes the preparation of a gas diffusion electrode for an electrochemical cell. This electrode is prepared using a carbon black powder dispersed in an organic solvent in the presence of soluble polyethylene. The dispersion is then dried, allowing the polyethylene to cover the surface of the black. This polyethylene is then fluorinated. Next, this hydrophobic carbon black powder is mixed with an acetylene carbon black supporting a catalyst metal and PTFE in order to form aggregates. Next, these aggregates are pressed at 20 kg/cm² and sintered at 340° C. for 20 minutes.

Patent EP 0928036 describes a method of preparing a gas-permeable electrode by making a dispersion of carbon black particles or of carbon black particles supporting a catalyst using a high-shear apparatus in order to homogenize it, such as a microfluidizer, then by adding a binder to the dispersion obtained followed by a stabilizer. Next, this mixture is deposited on an electrically conducting fabric and then dried and sintered at 300-400° C.

Patent Application WO 200030202 describes a mouldable composition used for preparing current collector plates by compression moulding or injection moulding. This composition comprises a non-fluorinated polymer binder; the polymers that can be used include polyphenylene sulphides, modified polyphenylene ethers, liquid-crystal polymers, polyamides, polyimides, polyesters, phenolic resins, epoxide resins and vinyl esters. The conducting particles include more particularly carbon particles. These carbon particles are present in an amount of at least 45% by weight. Fischer in Journal of applied electrochemistry 28 (1998) pp 277-282 has studied the preparation of an MEA (membrane and electrode assembly) by spraying a mixture of a slurry (suspension) of a catalyst metal, of a Nafion® (fluoroacrylate) solution in water and of glycerol onto a heated membrane based on Nafion 117®. The solvents are then evaporated by heating to 150° C.

U.S. Pat. No. 4,214,969 describes a bipolar plate for fuel cells, which consists of graphite and a fluoropolymer in a ratio of 2.5:1 to 16:1. These bipolar plates have a volume conductivity of 4×10⁻³ Ω.in. This graphite/fluoropolymer mixture is dry-blended in a blender for 25 minutes and then introduced into a hot compression mould.

Patent Application GB 2220666 describes a cospraying method for preparing carbon black particles coated very uniformly with synthetic latex particles. There is no mention of a fluoropolymer in the description or in the examples.

U.S. Pat. No. 5,720,780 describes a process for manufacturing electrodes or a separator, which comprises mainly three steps:

Step 1: PVDF powder (homopolymer) is mixed, in the absence of solvent, with one of the active principles of the battery (also in powder form); the composite powder obtained, therefore obtained by powder blending, is homogeneous; the patent insists on the mixing conditions which then have an effect on the electrochemical properties obtained. This homogenization may be carried out at room temperature or at a higher temperature, but in all cases below the melting point of the polymer.

Step 2: The powder obtained is left to “take up” a plasticizer (preferably dimethyl adipate), again with a mixing step.

Step 3: The plasticized powder is processed by pressing it at a well-defined temperature: T° (softening point)<T° (processing)<T° (polymer melting point). This pressing of the powder may be carried out directly on the current collectors (made of copper or aluminium).

According to this patent, a composite powder is firstly obtained which is then processed; the starting material is powdered Kynar® (PVDF), the average particle size of which, from about 5 to 20 μm, is known. The mean particle size of the lithiated oxide or graphite powders is of the same order; silica or carbon black are, on the other hand, much finer (<1 μm) fillers. Either objects (Kynar and graphite) approximately 10 μm in size are therefore mixed together or an object (Kynar) approximately 10 μm in size is therefore mixed with a fine object (silica or black). The patent does not specify what the particle size of the resulting composite powder is. It is mentioned that the mixing may be possibly carried out at a temperature, which nevertheless remains below the melting point of the PVDF.

Japanese Patent Application JP09219190 A published on Aug. 19, 1997 describes a process for manufacturing electrodes, which comprises three steps:

Step 1: PVDF (preferably a homopolymer) is dissolved in a solvent (preferably DMF: dimethyl formamide). Next, the active principles of the battery are added to this solution. The resulting mixture is called a slurry.

Step 2: This slurry is atomized at a temperature below the melting point of the polymer. What is more, there is no more than 50° C. difference between the atomization temperature and the boiling point of the solvent. Here again, a composite (spherical) powder is obtained, the mean diameter of which is 100 to 200 μm.

Step 3: The powder is processed, for example by pressing (but the pressing temperature is not mentioned), in order to obtain an electrode.

In this patent, the atomization technology is used to obtain a composite powder which is then processed. However, what is atomized is a slurry containing the active principles of the battery but in which the PVDF is in solution. The particle size of the composite powder obtained is given as 100 or 200 μm—hence a very coarse powder, knowing that it is desired to make electrodes as thin as possible (150 to 300 μm). The precise morphology of the composite powder is not known, but it is more than probable that the atomized PVDF, obtained from a solution, coagulates around fillers in the form of a film.

### THE TECHNICAL PROBLEM

In the prior art, the mixing of the fillers with the fluoropolymer is not sufficiently intimate. It has been discovered that, starting from a microcomposite powder comprising a fluoropolymer in the form of particles between 0.1 and 0.5 μm in size and fillers, it is possible to manufacture lithium-ion battery elements such as electroactive layers, electrodes and separators which are of much better quality. This microcomposite powder may be prepared by coatomization of an aqueous solution containing fluoropolymer particles between 0.1 and 0.5 μm in size and of an aqueous solution of the fillers. It may also be prepared by the flocculation or coagulation of an aqueous solution containing the fluoropolymer particles between 0.1 and 0.5 μm in size and of an aqueous solution of the fillers.

The use of a microcomposite powder makes it possible to predistribute the PVDF around the filler of active material (graphite in the case of the negative electrode of the battery, silica in the case of separators of the “Bellcore” type, and lithium metal oxide in the case of the positive electrode of the battery). This powder may be processed by very simple techniques (electrodeposition, pressing, extrusion with plasticizers, spreading of an aqueous paste). This powder may also be dispersed in a solvent. The solvent may either be water (the advantage is then that it is an environmentally friendly process) or a latent solvent such as acetone (the advantage is then the ease of processing) or NMP (as in the conventional processing of an electrode). The latent solvent swells the fluoropolymer and dissolves it at higher temperature. As there is not necessarily a step of dissolving the PVDF (that is to say it is possible to process the microcomposite powder by electrodeposition, pressing, extrusion with plasticizers, spreading of an aqueous paste or a water dispersion), it is possible to use either a VF2 homopolymer or copolymer indifferently. In fact, the homopolymer is more difficult to dissolve than the copolymer. However, it turns out that the homopolymer gives the battery better thermomechanical properties (higher operating temperature range). It is therefore an additional advantage of the present invention to be able to use a PVDF homopolymer.

The major difference between the present invention and the prior art JP09219190 A is the fact that in this prior art what is atomized is a slurry which contains the active principles of the battery but in which the PVDF is in solution. In the present invention, during the preparation of the microcomposite powder the fluoropolymer is always in the form of particles-between 0.1 μm-and 0.5 μm in size and not in solution; this is why the powders obtained are very different.

### BRIEF DESCRIPTION OF THE INVENTION

The present invention relates to a lithium-ion battery element which is chosen from the separator and the electroactive layers and which results from the processing of a microcomposite powder comprising a fluoropolymer in the form of particles between 0.1 and 0.5 μm in size and fillers.

The present invention also relates to a lithium-ion battery electrode comprising the above electroactive layer combined with a metal layer.

The present invention also relates to a lithium-ion battery comprising at least one element such as the separator, the electroactive layer or the electrode defined above.

This microcomposite powder may be prepared by coatomization of an aqueous solution containing the fluoropolymer particles between 0.1 and 0.5 μm in size and of an aqueous solution of the fillers. It may also be prepared by the flocculation or coagulation of an aqueous solution containing the fluoropolymer particles between 0.1 and 0.5 μm in size and of an aqueous solution of the fillers.

The processing of this microcomposite powder consists in preferably processing it in the form of film in order to obtain an electrode film or separator film. Next, these films are joined together to form a battery. This step (assembly, filling with electrolyte, packaging, etc.) is known per se.

### DETAILED DESCRIPTION OF THE INVENTION

With regard to the fluoropolymer, this is therefore understood to mean any polymer having in its chain at least one monomer which is chosen from compounds containing a vinyl group capable of opening in order to be polymerized and which contains, directly attached to this vinyl group, at least one fluorine atom, a fluoroalkyl group or a fluoroalkoxy group.

By way of example of monomers, mention may be made of vinyl fluoride; vinylidene fluoride (VF2); trifluoroethylene (VF3); chlorotrifluoroethylene (CTFE); 1,2-difluoroethylene; tetrafluoroethylene (TFE); hexafluoropropylene (HFP); perfluoro(alkyl vinyl) ethers such as perfluoro(methyl vinyl) ether (PMVE), perfluoro(ethyl vinyl) ether (PEVE) and perfluoro(propyl vinyl) ether (PPVE); perfluoro(1,3-dioxole); perfluoro(2,2-dimethyl-1,3-dioxole) (PDD); the product of formula CF₂═CFOCF₂CF(CF₃)OCF₂CF₂X in which X is SO₂F, CO₂H, CH₂OH, CH₂OCN or CH₂OPO₃H; the product of formula CF₂═CFOCF₂CF₂SO₂F; the product of formula F(CF₂)ₙCH₂OCF═CF₂ in which n equals 1, 2, 3, 4 or 5; the product of formula R₁CH₂OCF═CF₂ in which R₁ is hydrogen or F(CF₂)_{z} and where z equals 1, 2, 3 or 4; the product of formula R₃OCF═CH₂ in which R₃ is F(CF₂)_{z} and where z is 1, 2, 3 or 4; perfluorobutylethylene (PFBE); 3,3,3-trifluoropropene and 2-trifluoromethyl-3,3,3-trifluoro-1-propene.

The fluoropolymer may be a homopolymer or a copolymer; it may also comprise non-fluorinated monomers such as ethylene. Advantageously, the fluoropolymer is a PVDF homopolymer or copolymer.

The preferred polymers according to the invention are those obtained by emulsion polymerization (for a general description of this technology see, for example, “Principles of Polymerization” by G. Odin, Chapter 4, pp. 319-339, Wiley Interscience, 2nd Edition, 1981), that is to say polymers available in latex form. The preferred polymers according to the invention are fluoropolymers; among these, mention may be made of polyvinyl fluoride (PVF), polyvinylidene fluoride (PVDF), polychlorotrifluoroethylene (PCTFE), polytetrafluoroethylene (PTFE), tetrafluoroethylene/perfluoropropene copolymers (FEP), tetrafluoroethylene/perfluoroether copolymers (PFA), tetrafluoroethylene/ethylene copolymers (ETFE) and chlorotrifluoroethylene/ethylene copolymers (ECTFE). Among the fluoropolymers, PVDF, and more particularly PVDF prepared by aqueous emulsion polymerization, as described in U.S. Pat. No. 4,025,709, U.S. Pat. No. 4,569,978, U.S. Pat. No. 4,360,652, U.S. Pat. No. 626,396 and EP 0655468, is preferred.

The polymer latices that are useful within the meaning of the invention are characterized by solids contents, after the synthesis step, of between 15 and 70% by weight, preferably 25 to 60% by weight. The particle sizes of these latices are between 50 nm and 600 nm, preferably from 100 to 350 nm.

PVDF within the meaning of the invention is understood to mean the vinylidene fluoride (VF2) homopolymer but also VF2 copolymers containing at least 50% by weight of VF2, preferably at least 70% by weight of VF2 and even more preferably at least 85% by weight of VF2, and at least one other copolymerization monomer which may or may not be fluorinated. These copolymerizable monomers may allow possible subsequent crosslinking of the PVDF. Among copolymerizable fluoromonomers, mention may be made of chlorotrifluoroethylene (CTFE), hexafluoropropylene (HFP), trifluoroethylene (VF3) and tetrafluoroethylene (TFE). Among the copolymerizable fluoromonomers, HFP and CTFE are preferred. Among the non-fluorinated copolymerizable monomers, mention may be made of vinyl or allyl ethers or esters. Among the non-fluorinated copolymerizable monomers, the monomers allowing the adhesion of PVDF to metals particularly copper and aluminium, to be improved are preferred.

The fluoropolymer may also be an AMF (Acrylic Modified Fluoropolymer). This AMF is advantageously in latex form. An AMF latex is obtained by starting the polymerization by the fluorinated part (VF2 homopolymer or copolymer) and then the acrylic monomers are introduced, such as MAM (methyl methacrylate), butyl acrylate or a functional monomer such as GMA (glycidyl methacrylate), which are polymerized. Since the acrylic monomers, and in particular MAM, are extremely compatible with PVDF, these monomers can diffuse into the initial fluorinated particle (called a seed). Thus, the elementary AMF particle has quite a homogeneous structure, and an almost miscible alloy is manufactured already at polymerization. Of course, there are many variants, for example with regard to the duration and flow rate of the monomer introduction (it is also possible to make the PVDF latex in a first reactor, then to transfer it into another reactor, possibly after a storage time, and then the acrylic part is made), but the general principle applies thereto. Among AMFs, the following are preferred:

AMFs based on PVDF or VF2/HFP;

AMFs having at least 70% by weight and preferably 85% by weight of fluoromonomer;

AMFs having, in the acrylic part, monomers allowing the adhesion of PVDF to metals, particularly copper and aluminium, to be improved.

The PVDF latex may also consist of a mixture of latices, in which at least one of the latices is a PVDF latex and the other one or more latices are fluoropolymer latices. For example, it is possible to use a mixture of a VF2 homopolymer latex and of a VF2/HFP copolymer latex, or a mixture of a VF2 homopolymer latex and of a copolymer of VF2 with a monomer which promotes the adhesion of PVDF to metals, or a mixture of a VF2 homopolymer latex and of a PTFE latex. Latex mixtures containing at least 50% by weight of VF2, preferably at least 70% by weight of VF2, are preferred.

This latex mixture, in which at least one of the latices is a PVDF latex, may also comprise one or more non-fluorinated polymer latices. Among non-fluorinated polymers, mention may be made of acrylic emulsions, vinyl-acetate-based emulsions, vinyl-chloride-based emulsions and emulsions of butadiene-based elastomers. Among non-fluorinated polymers, acrylic polymers, and more particularly acrylic polymers and copolymers based on methyl methacrylate or ethyl acrylate having a glass transition temperature greater than or equal to 40° C., preferably greater than or equal to 60° C., are preferred. More particularly, acrylic polymers and copolymers containing, in addition, copolymerizable monomers promoting the adhesion of the compositions according to the invention to metals, are also preferred. Among these monomers, mention may be made of monomers having one or more functional groups of the type comprising acids, anhydrides, hydroxyls, amines and corresponding salts, silanyls and their hydrolysed form, epoxides, ureido derivatives, phosphates, sulphonates, etc. In these latex mixtures, in which at least one of the latices is a PVDF latex, mixtures containing at least 70% by weight of VF2, and preferably at least 85% by weight of VF2, are preferred.

The essentially PVDF-based latex or latex mixture may also contain in its aqueous phase one or more water-soluble polymers. Among water-soluble polymers, those promoting the adhesion of the compositions according to the invention to metals are preferred. In these mixtures of one or more essentially PVDF-based latices and of one or more water-soluble polymers, mixtures containing at least 70% by weight of VF2, preferably at least 85% by weight of VF2, are preferred.

It is also possible to introduce into the latex or latex mixtures according to the invention small organic molecules (molar mass <1000 g/mol) making it possible to promote the adhesion of the compositions according to the invention to metals. Among these small organic molecules, mention may be made of 5-sulphoisophthalic acid and its metal salts. The preferred amount of addition of these adhesion promoter molecules is less than 5% by weight with respect to the fluoropolymer.

As regards the fillers, a distinction must be made between the silica that is used for the separator and those that are used for the electroactive layers.

Lithium metal oxides of the LiMₓO_{y} type, in which M is a metal, are used for producing the electroactive layers of the positive electrodes. Advantageously, M is a transition metal such as Mn, Ni or Co.

Carbon-based products are used for producing the electroactive layers of the negative electrodes. By way of example of carbon-based products, mention may be made of graphite, carbon black aggregates, carbon fibres and active carbons. It would not be outside the scope of the invention to use several carbon-based products, for example (i) graphite and carbon black aggregates; (ii) graphite, carbon black aggregates and carbon fibres; (iii) carbon black aggregates and carbon fibres; (iv) graphite and carbon fibres.

The carbon-based products that can be used are described in “Handbook of Fillers”, 2nd Edition, published by Chem Tec Publishing, 1999, page 62 §2.1.22, page 92 §2.1.33 and page 184 §2.2.2. Preferably, graphites having a size of between 20 and 50 μm will be used. Among carbon blacks that can be used, mention may be made of Ketjen® EC 600 JD black having a specific surface area of 1250 m²/g, Ketjen® EC 300 J black having a specific surface area of 800 m²/g and the black from 3M sold under the reference Super P, characterized by a specific surface area of about 57 to 67 m²/g (measured by the BET nitrogen adsorption method). It may be advantageous to use carbon fibres having a length of 150 μm.

As regards the microcomposite powder, this may comprise, by weight, in the case of those used in the electroactive layers, 2 to 40% of a fluoropolymer for 98 to 60% of fillers, respectively. Advantageously, the powder comprises 2 to 30% of a fluoropolymer for 98 to 70% of fillers, respectively. As regards the powder used for the separator, the proportions are 20 to 80% of a fluoropolymer for 80 to 20% of fillers, respectively. In the above proportions, the fluoropolymer may possibly contain plasticizers or additives.

The microcomposite powder is in the form of particles of fillers advantageously covered, uniformly, with fluoropolymer particles. The fluoropolymer particles, having a size of between 0.1 and 0.5 μm, may partly or completely cover the filler particles.

The silica has a size of about 1 to 50 μm; the lithium metal oxides of the LiMₓO_{y} type have a size of 1 to 50 μm; the graphite has a size of 1 to 50 μm; the carbon black may have a size of 40 nm and the carbon fibres have a size of between 1 and 300 μm.

The microcomposite powder may be in the form of agglomerates of 2 or more filler particles coated with the fluoropolymer and bound by the fluoropolymer particles. These agglomerates may be shaped like a raspberry. In general, these agglomerates contain between 2 and 5 filler particles.

The present invention also relates, as product, to a microcomposite powder in the form of silica particles advantageously covered, uniformly, with fluoropolymer particles. The fluoropolymer particles, having a size of between 0.1 and 0.5 μm, may partly or completely cover the silica particles.

This microcomposite powder may be prepared by the coatomization of an aqueous solution containing the fluoropolymer particles between 0.1 and 0.5 μm in size and of an aqueous solution of the fillers. It may also be prepared by the flocculation or coagulation of an aqueous solution containing the fluoropolymer particles between 0.1 and 0.5 μm in size and of an aqueous solution of the fillers.

As regards the manufacture of the microcomposite powder by flocculation or coagulation, the finishing technologies for an aqueous dispersion are known per se. Coagulation is described in the chapter “Drying” by P. Y. McCormick in “Encyclopedia of Polymer Science and Engineering”, Vol. 5, pp. 187-203, Wiley Intersciences, 1990. This also describes the coagulation of an aqueous dispersion containing the polymer latex or latex mixture and the fillers, in which, for example, rotary dryers are referred to. Flocculation is also mentioned in the chapter “Flocculation” by G. R. Rose in “Encyclopedia of Polymer Science and Engineering”, Vol. 7, pp. 211-233, Wiley Intersciences, 1990. It is possible, for example, to make the aqueous dispersions based on polymers and fillers flocculate by suddenly cooling the dispersion, or by reducing the solids content of the dispersion by partial drying, or else by adding a surfactant to the dispersion or a salt which destabilizes it. Once the dispersion has flocculated, the aqueous phase is removed in order to recover the composite powder, for example by drying or filtering.

As regards the manufacture of the microcomposite powder by atomization (or coatomization), this atomization technique is known per se. For a general description of this technology see, for example, the chapter “Drying” by P. Y. McCormick in “Encyclopedia of Polymer Science and Engineering”, Vol. 5, pp. 187-203, Wiley Intersciences, 1990. The microcomposite powders incorporating the active principles of the battery (also denoted by the name of fillers in this text) are in general obtained by atomizing an aqueous dispersion containing the polymer latex or latex mixture together with the active principles of the battery.

The aqueous dispersion of the active principles is also called a slurry. The precise preparation conditions depend strongly on the nature of the active principles, in particular on the hydrophobicity or hydrophilicity of their surface, on the amount of surface present in the system (which depends on the solids content of the dispersion and on the specific surface area of the active principles), on the solids content and on the desired viscosity. In general, the preparation of a slurry may comprise the following steps, for which a disperser fitted with a stirrer (blades, etc.) is used: dispersants, surfactants, fungicides, antifoams, pH regulators, etc. are added to water (if possible demineralized and/or deionized water) and the required amount of active principles is added gradually with moderate to average stirring. Next, the dispersion is in general homogenized at a higher stirring speed. The nature of the dispersants varies according to the active principle. For example, it is possible to use the salified water-soluble acrylic copolymers. More particularly, the invention is illustrated in the following three ways:

In a first illustration of the invention, an aqueous dispersion is prepared by mixing, with stirring, the fluoropolymer latex or latex mixture and the aqueous dispersion or dispersions (also called slurries) of the active principles of the battery. Next, this aqueous dispersion is atomized in order to result in a composite power which can then be processed in various ways. An important and significant variant of this illustration consists of the coatomization in the same atomizer of the fluoropolymer latex or latex mixture and of the slurry or slurries of the active principles of the battery. In this case, the latex or latices and the slurry or slurries are each introduced into the atomizer via a separate and dedicated nozzle. This technique makes it possible to dispense with the step of preparing the aforementioned dispersion.

In a second illustration of the invention, the active principles of the battery in dry form are added directly and with stirring to the fluoropolymer latex or latex mixture. Next, this aqueous dispersion is atomized in order to produce a microporous composite powder.

The third illustration of the invention involves, apart from the polymers and active principles already mentioned, one or more organic compounds characterized by the presence of at least one carbonyl or carbonate group, the affinity for VF2-based polymers of which is known. These organic compounds are chosen from solvents and plasticizers used in the composition of the liquid electrolyte serving to activate the battery. By way of examples, mention may be made of the family of carbonates and more particularly of ethylene carbonate (EC), propylene carbonate (PC), dimethyl carbonate (DMC), dimethyl phthalate (DMP), diethyl phthalate (DEP) and those mentioned in U.S. Pat. No. 5,456,000 and U.S. Pat. No. 5,720,780. By way of examples of plasticizers, mention may be made of the family of sebacates, phthalates, succinates, oxalates, adipates and suberates, which may or may not be substituted, and more particularly dioctyl phthalate (DOP), dibutyl sebacate (DBS) and dibutyl phthalate (DBP).

The aqueous dispersions of illustrations 1, 2 and 3 intended to be atomized are preferably prepared in a disperser with stirring. These dispersions are preferably kept stirred until the atomization step. During the step of preparing the dispersions, a small amount of additives such as, for example, adhesion promoters, dispersants and other surfactants, antifoam agents, fungicides and pH regulators, may also be added. The relative proportion of polymer latices and of active principles (in slurry form or dry filler form) is chosen so as to obtain, after atomization, the final desired dry composition. The solids content of the dispersion may be adjusted in order to promote the atomization step. This solids content also depends on the amount of surface present in the system. In general, it is desired to maintain the maximum solids content before atomization. In the case of coatomization, the respective flow rates of the latex or latices and slurry or slurries are chosen in order to obtain, after atomization, the desired final dry composition. In the case of active principles used in the composition of the electrodes (anode and cathode), it is desirable to incorporate the maximum amount of active principles, preferably at least 70% by weight and even more preferably at least 85% by weight. In the case of active principles used in the composition of a separator, the degree of incorporation of the active principles is lower than in the case of the electrodes. Preferably, it is between 20 and 60% by weight.

The conditions under which the aqueous dispersions are atomized, and in particular the temperature of the hot air entering the atomizer, are specific to the polymers used. In the case of a VF2 homopolymer, an atomization temperature of 175° C. is used for example. The particle size of the composite powder obtained depends on the atomization conditions themselves, but also on the nature of the dispersion to be atomized and in particular on the particle size of the active principles of the battery. The median diameter, containing 50% of the volume distribution measured by laser diffraction, is in general between 2 and 150 μm, preferably between 2 and 40 μm, when these are powders not containing carbon fibres. The atomization conditions may be adjusted in order to modify the particle size distribution of the composite powders so as to promote such or such a subsequent processing technology.

When the invention involves organic compounds, such as solvents for the liquid electrolyte and plasticizers, two modes of incorporation may be distinguished. These organic compounds may be present in the dispersion of polymer and of active principles of the battery before the atomization step. In this case, the preferred organic compounds have a boiling point high enough for them to remain, completely or partly, in the atomized powder. They may also be added to and mixed with the powder, after it has been atomized, in a suitable mixer, possibly heated if the organic compound is a solid at room temperature (in the case of ethylene carbonate). Among these organic compounds, those preferred are both plasticizers for PVDF and solvents for the liquid electrolyte (ethylene carbonate, propylene carbonate, dimethyl carbonate, diethyl carbonate, ethylmethyl carbonate, vinyl carbonate and gamma-butyrolactone); other compounds are mentioned in U.S. Pat. No. 5,720,780, since these organic compounds must all be present in the activated battery. The presence of plasticizer in the composite powder is used to facilitate the subsequent processing of the powder, this processing being carried out above the melting point of the polymer (in which case the plasticizer facilitates the conversion by reducing the melt viscosity) or below the melting point of the polymer (in which case the plasticizer favours the coalescence of the powder).

As regards the processing of the powder obtained by (co)atomization, flocculation or coagulation of the aqueous dispersions described above, it may undergo a post-treatment before it is processed. The addition of organic molecules having good affinity with PVDF has already been mentioned, but the following operations may also be envisaged:

Washing of the composite powder, particularly so as to remove certain dispersants or surfactants, if these prove to have a negative effect on the electrochemical operation of the battery;

The addition of additives to the composite powder, for example adhesion promoters;

Vacuum drying of the powder, particularly in order to remove traces of moisture.

The composite powder according to the invention may be processed in order to result in components—electrodes and separators—useful for obtaining lithium-ion batteries using a wide variety of methods, among which two large families may be distinguished:

Processing without solvents: sintering, pressing, extrusion, lamination, calendering, deposition of composite powder by screening, electrostatic or triboelectric powder coating and any combination of these technologies, particularly extrusion/lamination/calendering and powder coating/calendering (see Example 3). These processing methods result in free films or supported films. The films obtained have a thickness of between 25 μm and 5 mm, preferably between 50 μm and 500 μm.

Processing with solvents: the electrodes or the separator are obtained by redispersing this powder either in water (the advantage then being an environmentally friendly process) or in a latent solvent such as acetone (the advantage then being the ease of processing), or in NMP (as in the conventional processing of an electrode), and then by immediately applying the “paste” formed with a doctor blade to a support and by evaporating the solvent used (see Examples 12 and 13). In this regard, the above procedure is similar to that used throughout the lithium-ion battery industry, thereby making it possible to incorporate it without any difficulty in current equipment. The advantage afforded by the invention is at this point a greater flexibility in the choice of solvent and a better appearance of the electrodes because the PVDF has been distributed beforehand around the active material.

In the case of powders used for manufacturing electrodes, processing methods carried out directly on the metal collectors are preferred. These supports may be metal foils or metal grids or metal foams (made of copper, aluminium, nickel, etc.) or metal alloys. These metal substrates may possibly be treated so as to promote the adhesion of the films. For negative electrodes, the metal is advantageously copper and for positive electrodes it is advantageously aluminium.

In the case of powders used for manufacturing separators, the processing may result in a free film (this is the case of extrusion using a sheet die) or can be carried out on a non-stick support so as to subsequently facilitate transfer of the film. The composite powder film used for manufacturing separators may also be formed directly on an electrode film.

These processing methods may be carried out above or below the melting point of the fluoropolymer employed, thereby making it possible to control the morphology of the film obtained. In the case of PVDF, the melting point of the homopolymer is about 170° C.

As regards obtaining a battery, the final mounting is known per se and has been described, for example, in U.S. Pat. No. 5,296,318, U.S. Pat. No. 5,939,217, U.S. Pat. No. 5,999,102, U.S. Pat. No. 5,805,069, U.S. Pat. No. 5,804,333 and U.S. Pat. No. 5,633,099. In most cases, the process involves cowinding a positive electrode, a separator and a negative electrode and placing the assembly in a rigid package (of the aluminium cylinder type) or a flexible package, making the connection to the two poles of the battery, then activating the battery by filling it with the electrolyte (LiPF₆ or LiBF₄ or any other lithium salt in a carbonate or gamma-butyrolactone solvent mixture).

### EXAMPLES

The following products were used:

PVDF Latex No. 1 is a VF2 homopolymer latex obtained by emulsion polymerization and characterized by a solids content of 35% by weight (measured by residual weighing after drying the latex for 10 minutes at 160° C. in an apparatus of the HG53 type from the company Mettler Toledo) and by a mean particle size of 140 nm (measured by laser diffraction on a particle size analyser of the Coulter brand). The PVDF obtained is characterized by a melt viscosity of 1200 Pa.s at 230° C. and at a shear rate of 100 s⁻¹, by a melting point of 171° C. (measured according to the ISO 3146 standard) and by a tensile elastic modulus at 23° C. of 2200 Mpa (measured according to the ISO 527 standard). The relative density of the PVDF is 1.78 (measured using the ISO 1183 standard).

PVDF Latex No. 2 is a VF21 HFP copolymer latex (10% by weight HFP) obtained by emulsion polymerization and characterized by a solids content of 31% by weight and by a mean particle size of 230 nm. This PVDF is characterized by a melt viscosity of 2350 Pa.s at 230° C. and at a shear rate of 100 s⁻¹, by a melting point of 164° C. and by a tensile elastic modulus at 23° C. of 690 Mpa. Its relative density is 1.78.

PVDF Latex No. 3 is a VF2/HFP copolymer latex (12% by weight of HFP) obtained by emulsion polymerization and characterized by a solids content of 31% by weight and by a mean particle size of 230 nm. This PVDF is characterized by a melt viscosity of 2500 Pa.s at 230° C. and at a shear rate of 100 s⁻¹, by a melting point of 143° C. and by a tensile elastic modulus at 23° C. of 700 Mpa. Its relative density is 1.78. After atomization and drying, the powder obtained from this Latex No. 3 is called PVDF No. 3.

PVDF No. 3: see the previous paragraph.

The graphite is a product commercially available from Osaka Gas Chemicals Co. under the name MCMB 6-28. It is characterized by a median diameter corresponding to 50% of the volume distribution of about 8 μm and by a diameter corresponding to 98% of the volume distribution of about 25 μm (measured by laser diffraction using a Helos particle size analyser of the SYMPATEC brand). It has an actual relative density of 2.21.

The conducting carbon black is a product commercially available from 3M under the reference SUPER P. It is characterized by a specific surface area of about 57 to 67 m²/g (measured by the BET nitrogen adsorption method). The mean particle size observed by the supplier in electron microscopy is approximately 40 nm. The actual relative density of the black is 1.93.

The aqueous silica dispersion (slurry) is a product available from Rhodia under the reference TIXOSIL 365 SP. The solids content of this dispersion is 22%. The silica is characterized by a specific surface area of about 155 m²/g and an actual relative density of 2.00.

The copper foil is a product commercially available in reel form from Fukuda Metal Foil & Powder Co. under the reference CF-LB2-12. This foil is obtained by the electrodeposition of copper and is characterized by a thickness of 12 μm and by a width of 350 mm.

### Example 1

### Preparation of the Aqueous Graphite/Carbon Black Dispersion (Slurry)

The constituents of the aqueous graphite/carbon black dispersion (slurry) were gradually introduced into a multiblade-turbine disperser of the DISPERMAT brand with moderate stirring (100 rpm).

| | | Solids content by |
|---|---|---|
| | | weight of the |
| Order of | | constituent |
| introduction | Nature of the constituent | (%) |
| 1 | Demineralized water | see below |
| 2 | Antifoam agent of the siloxane modified polyether type | 0.05 |
| | (a commercially available product from BYK Chemie | |
| | under the name BYK 019). | |
| 3 | Dispersant of the potassium polycarboxylate type (a | 3.05 |
| | commercially available product from Coatex under the | |
| | name COADIS 123 K). | |
| 4 | Graphite | 94.45 |
| 5 | Carbon black | 2.45 |

The amount of demineralized water introduced is such that the solids content by weight of this dispersion is 60%. After introducing the constituents, the mixture is then homogenized at a speed of 1000 rpm.

### Example 2

### Preparation of the Composite Powder Based on PVDF Latex, Graphite and Carbon Black

Gradually introduced, with moderate stirring (300 rpm), into the same disperser as previously, containing the homogeneous aqueous graphite/carbon black dispersion (slurry) of Example 1, was the PVDF Latex No. 1 in proportions such that the solids content by weight of graphite+carbon black with respect to the total graphite+carbon black+PVDF was 86%. Demineralized water was also added gradually so as to bring the overall solids content by weight of the slurry/latex mixture to 20%.

This continuously stirred liquid mixture was then atomized in an atomizer of the Minor Mobile type (manufactured by NIRO) under the following conditions:

hourly flow rate of the mixture: 2 l/h; set inlet temperature of the hot air entering the turbine: 175° C.;

measured outlet temperature of the outgoing air: 55° C.;

air pressure determining the turbine speed: 2.2 bar.

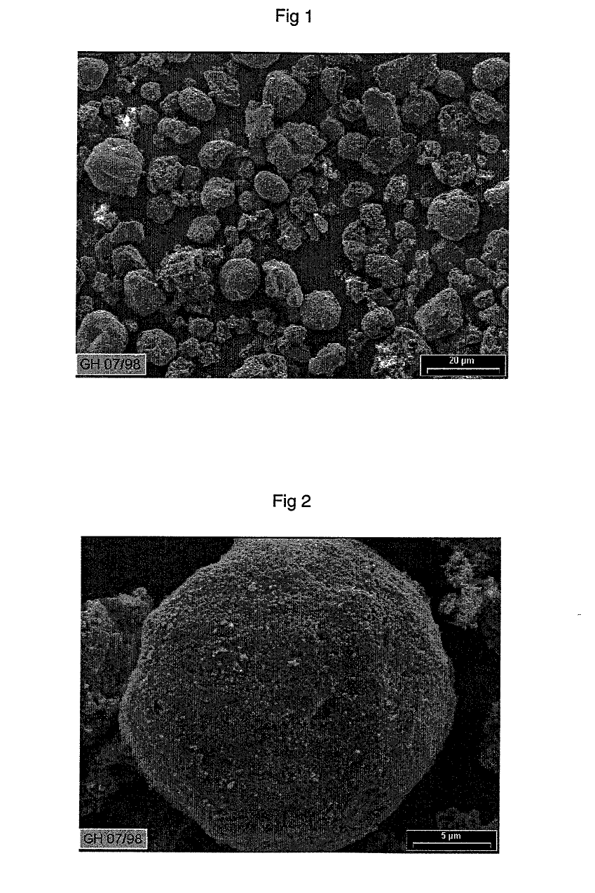

The microporous composite powder obtained is characterized by a median diameter corresponding to 50% of the volume distribution of about 9 μm and by a diameter corresponding to 98% of the volume distribution of about 30 μm (measured by laser diffraction in a Helos particle size analyser of the SYMPATEC brand). A representative morphology (photographs obtained in scanning electron microscopy using-an apparatus of the FEG-XL30 type from Philips) of the powder and of a microporous particle of this powder is shown in FIGS. 1 and 2. FIG. 1 shows graphite particles 5 to 15 μm in size covered with a white substance; FIG. 2 is an enlargement of the previous figure, showing a graphite bead covered with small white PVDF particles. The powder was dried for 15 days at 40° C. in a fan-assisted oven before use.

### Example 3

### Processing by Powder Coating+Calendering of the Composite Powder of Example 2

The reel of copper was at the front of the plant, the copper foil being unreeled and passed over intermediate rolls. The rate of unwinding adopted was 1.2 m/min. The composite powder of Example 2 was deposited by a triboelectric effect (using a powder gun) in the form of a uniform layer (the thickness of this layer depended on the desired final thickness after calendering). The copper foil was heated to about 200° C. using an infrared source so as to encourage the coalescence of the uniform layer and its adhesion to the copper foil. A second infrared source was placed downstream of the powder gun so as to heat the upper surface of the uniform layer.

Next, the entire copper foil covered with the uniform layer passed through a calendering unit between a rubber roll and a controlled (heated or cooled) metal roll. Thereafter, this assembly, now constituting an electrode according to the invention, then had a thickness of about 140 μm. The temperature of the rubber roll was obtained by conduction from an adjacent second controlled (heated or cooled) metal roll. Next, the assembly passed over a third controlled (heated or cooled) metal roll. The temperatures of all these rolls could vary between 25 and 160° C. They were chosen so as to favour the formation of a skin of good strength and to prevent any deposition of composite powder on the rolls. Next, the electrode passed over a set of rolls which made it possible to adjust the tension in the reel. Finally, the electrode was wound up.

### Example 4

### Processing by Pressing the Microporous Composite Powder of Example 2

The composite powder according to the invention could also be processed by pressing in order to result in a free film. Deposited on the platens of a laboratory hydraulic press of the LABO 60 type from Pinette Emidecau Industries was a suitable amount of composite powder of Example 2. Siliconized paper was deposited beforehand on the platens of the press so as to make it easier to recover the film. The composite powder of Example 2 was pressed at a platen temperature of 250° C. according to the following pressure cycle: 1 minute without pressure, then 30 seconds at 4 bar followed by 1 minute at 34 bar. After the cooling cycle, a free film 600 μm in thickness was obtained which could, for example, then be laminated to a copper foil so as to form an electrode useful for manufacturing Li-ion batteries. In this example, the temperature of the platens, the pressing time and the applied pressure could be chosen so as to vary the thickness, the cohesion and the morphology of the film.

### Example 5

### Characterization of the Film of Example 4

The following two tests were carried out on the film of Example 4:

Indirect measurement of the average porosity: five specimens of set shape and dimensions (a parallelepiped of 20 mm a side and 600 μm in thickness), and therefore of known volume, were cut out from the film of Example 4 using a razor blade. Knowing the composition by weight of PVDF, graphite and carbon black, together with useful relative densities, the relative density of a film without any porosity was calculated, namely 2.13. The theoretical weight of specimens without any porosity (511 mg) was then calculated. Comparing this result with the average value (307 mg) measured on the five specimens allowed the average porosity to be calculated, namely 40%.

Average EC/DMC mixture weight uptake measurement: three specimens of free form were taken from the film of Example 4. These specimens were introduced into a thermostated (60° C.) glass reactor containing a 50/50 mixture by weight of ethylene carbonate (EC) and dimethyl carbonate (DMC). The average weight uptake of the specimens at equilibrium, observed after two days, was measured. From this an average percentage EC/DMC weight uptake was calculated, namely 42.5%.

### Example 6

### Preparation of the Microporous Composite Powder Based on PVDF and Silica

Gradually introduced, with moderate stirring (300 rpm), into the disperser of Example 1, containing the homogeneous aqueous silica dispersion, was the PVDF Latex No. 2 in proportions such that the solids content by weight of silica with respect to the silica +PVDF total was 40%. Demineralized water was also added gradually so as to bring the overall solids content by weight of the slurry/latex mixture to 11%.

This liquid mixture, kept stirred, was then atomized in an atomizer of the Minor Mobile type (manufactured by NIRO) under the following conditions:

hourly flow rate of the mixture: 2 l/h;

set inlet temperature of the hot air entering the turbine: 175° C.;

measured outlet temperature of the outgoing air: 60° C.;

air pressure determining the turbine speed: 2.2 bar.

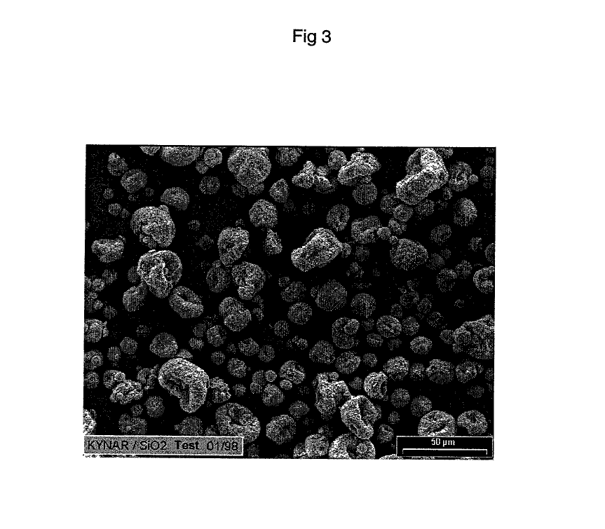

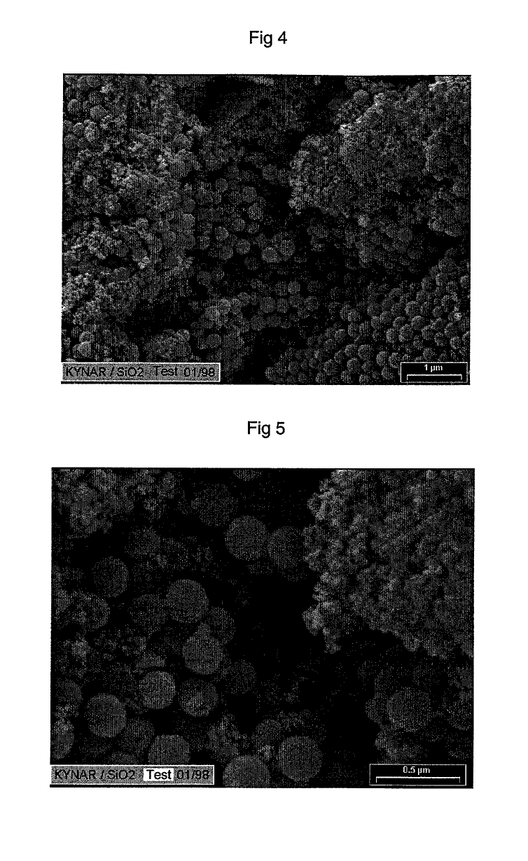

The microporous composite powder obtained was characterized by a median diameter corresponding to 50% of the volume distribution of about 3 μm and by a diameter corresponding to 98% of the volume distribution of about 15 μm (measured by laser diffraction in a Helos particle size analyser of the SYMPATEC brand). A representative morphology (photographs obtained in scanning electron microscopy using an apparatus of the FEG-XL30 type from Philips) of the powder and of a microporous particle of this powder is shown in FIGS. 3, 4 and 5. FIG. 3 shows silica particles covered with PVDF particles. FIG. 4, which is an enlargement of the previous figure, shows small PVDF beads on the surface of silica particles. FIG. 5 is an enlargement of the previous figure. The powder was dried for 15 days at 40° C. in a fan-assisted oven before use.

### Example 7

### Processing by Pressing the Microporous Composite Powder of Example 6

Deposited on the platens of a laboratory hydraulic press of the LABO 60 type from Pinette Emidecau Industries was a suitable amount of composite powder of Example 6. Siliconized paper was deposited beforehand on the platens of the press so as to make it easier to recover the film. The composite powder of Example 2 was pressed at a platen temperature of 220° C. according to the following pressure cycle: 1 minute without pressure, then 30 seconds at 4 bar followed by 1 minute at 150 bar. After the cooling cycle, a free film 350 μm in thickness was obtained which could, for example, then be assembled with the electrode of Example 3. In this example, the temperature of the platens, the pressing time and the applied pressure could again be chosen so as to vary the thickness, the cohesion and the morphology of the film.

### Example 8

### Characterization of the Film of Example 7

The following two tests were carried out on the film of Example 7:

Indirect measurement of the average porosity: five specimens of set shape and dimensions (16 mm diameter disk 350 μm in thickness), and therefore of known volume, were taken from the film of Example 7. Knowing the composition by weight of PVDF and of silica, together with the useful relative densities, the relative density of a film without porosity was calculated, namely 1.86. The theoretical weight of specimens without any porosity (131 mg) was then calculated. Comparing this result with the measured average value (86 mg) of the five specimens allowed the average porosity to be calculated, namely 34%.

Average EC/DMC mixture weight uptake measurement: three specimens of free form were taken from the film of Example 7. These specimens were introduced into a thermostated (60° C.) glass rector containing a 50/50 mixture by weight of ethylene carbonate (EC) and dimethyl carbonate (DMC). The average weight uptake of the specimens at equilibrium, observed after two days, was measured. From this an average percentage EC/DMC weight uptake was calculated, namely 93%.

### Example 9

### Preparation of the Aqueous Graphite Dispersion (Slurry)

The constituents of the aqueous graphite/carbon black dispersion (slurry) were gradually introduced with moderate stirring (100rpm) into a multiblade-turbine disperser of the DISPERMAT brand.

| | | Solids content |
|---|---|---|
| Order of | | by weight of the |
| introduction | Nature of the constituent | constituent (%) |
| 1 | Demineralized water | see below |
| 2 | Dispersant of the potassium polycarboxylate type | 1.1 |
| | (a commercial product available from Coatex under | |
| | the name COADIS 123 K). | |
| 3 | Graphite | 98.9 |

The amount of demineralized water introduced was such that the solids content by weight of this dispersion was 60%. After the constituents had been introduced, the mixture was then homogenized at a speed of 1000 rpm.

### Example 10

### Preparation of the Composite Powder Based on PVDF Latex and Graphite

Gradually introduced, with moderate stirring (300 rpm), into the same disperser as previously, containing the homogeneous aqueous graphite dispersion (slurry) of Example 9, was the PVDF Latex No. 3 in proportions such that the solids content by weight of graphite with respect to the graphite+PVDF+dispersant total was 90%. Demineralized water was also added gradually so as to bring the overall solids content by weight of the slurry/latex mixture back to 20%.

This liquid mixture, kept stirred, was then atomized in an atomizer of the Minor Mobile type (manufactured by NIRO) under the following conditions:

hourly flow rate of the mixture: 2 I/h

set inlet temperature of the hot air entering the turbine: 175° C.;

measured outlet temperature of the outgoing air: 55° C.;

air pressure determining the turbine speed: 2.2 bar.

The microporous composite powder obtained was characterized by a median diameter corresponding to 50% of the volume distribution of about 9 μm and by a diameter corresponding to 98% of the volume distribution of about 30 μm (measured by laser diffraction in a Helos particle size analyser of the SYMPATEC brand).

### Example 11 (Comparative Example)

### Processing of a Negative Electrode for an Li-Ion Battery According to the Prior Art

5 g of PVDF No. 3 were dissolved in 45 g of N-methyl-2-pyrrolidone (abbreviated hereafter to NMP, from Merck, with a purity of >99%) in an Erlenmayer flask with magnetic stirring at 55° C. over two hours. 45 g of graphite powder and 15 g of NMP were added to this solution. These powders were dispersed in the solution by magnet stirring at room temperature for 15 minutes, and then for five minutes in a multiblade-turbine disperser of the DISPERMAT brand with vigorous stirring (2000 rpm). The slurry obtained was then spread out over a copper foil 20 μm in thickness and then a film was formed by means of a manual doctor blade set at 400 μm. The film was dried at 130° C. in a fan-assisted oven for 10 minutes and then at 130° C. in a vacuum oven for one hour. Next, this electrode obtained was pressed for three minutes at 130° C. with a pressure of seven metric tons in order to reduce its porosity and improve the surface appearance. The conducting layer thus formed on the copper foil consisted of 10% by weight of PVDF No. 3 and 90% graphite. Its thickness was 120 μm on average.

### Example 12

### Processing by an “NMP” Route of a Negative Electrode of the Composite Powder of Example 10

20 g of the powder of Example 10 were dispersed in 35 g of NMP in a multiblade-turbine disperser of the DISPERMAT brand with vigorous stirring (2000 rpm) at room temperature for five minutes. The slurry obtained was spread out over a copper foil 20 μm in thickness and then a film was formed by means of a manual doctor blade set to 400 μm. The film was dried at 130° C. in a fan-assisted oven for 10 minutes and then at 130° C. in a vacuum oven for one hour. Next, this electrode obtained was pressed for three minutes at 130° C. with a pressure of seven metric tons in order to reduce its porosity and improve the surface appearance. The conducting layer thus formed on the copper foil consisted of 9% by weight of PVDF No. 3, 1% COADIS 123K (total organic matter=10%) and 90% graphite. Its thickness was 120 μm on average.

### Example 13

### Processing by the “Acetone” Route of a Negative Electrode of the Composite Powder of Example 10

20 g of the powder of Example 10 was dispersed in 35 g of acetone (NORMAPUR grade from Prolabo) with a spatula in an Erlenmayer flask at room temperature for five minutes. The slurry obtained was spread out over a copper foil 20 μm in thickness and then a film was formed by means of a manual doctor blade set at 400 μm. The film was dried at room temperature for 30 minutes. Next, this electrode obtained was pressed for three minutes at 130° C. with a pressure of seven metric tons in order to reduce its porosity and improve the surface appearance. The conducting layer thus formed on the copper foil consisted of 9% by weight PVDF No. 3, 1% COADIS 123K (total organic matter =10%) and 90% graphite. Its thickness was 120 μm on average.

### Example 14

### Determination of the Adhesion Properties Between the Conducting Layer and the Metal Foil of a Negative Electrode

Strips 25 mm in width and at least 10 cm in length were cut from the assembly described in Example 11, in Example 12 or in Example 13, and were then fixed to a rigid metal support by a double-sided adhesive tape (of the TESA brand reference #4970) of the same width to the conducting layer face. The assembly was held against the support by simple hand pressure. The rigid metal support/double-sided adhesive tape/conducting layer/metal foil combination is called a “peel test piece”.

Next, the peel test pieces were fitted into a DY30 tensile testing machine distributed by Adamel Lhomargy. The metal support was kept fixed. Failure between the conducting layer and the aluminium foil was initiated either by hand or by means of a razor blade. The free part of the aluminium foil was fixed to a moveable jaw and then pulled at 180° with a pull rate of 100 mm/min. The instantaneous tensile force was determined by a 10 N force cell. The mean value of this force during the peeling between the metal foil and the conducting layer is called the “peel force”.

### Example 15

### Empirical Determination of the Flexibility of a Negative Electrode

Strips at least 5 cm in length and at least 2 cm in width were cut from the assembly described in Example 11, in Example 12 or in Example 13. These strips were wound onto a metal bar 1 mm in diameter or were folded up on themselves. We then assigned the following ratings:

| Rating | Comments |
|---|---|
| 0 | Very poor flexibility, immediate fracture on |
| | the 1 mm diameter bar |
| 1 | Moderate flexibility, slight fracture on the |
| | bar and significant fracture when folding |
| 2 | Good flexibility, no fracture on the bar and |
| | slight fracture when folding |
| 3 | Excellent flexibility, no fracture during |
| | either operation |

### Example 16

### Comparison Between a Negative Electrode According to the Invention Obtained with a Microcomposite Powder and an Electrode Obtained without this Microcomposite Powder

Using the evaluation procedure described in Examples 14 and 15, the peel force, between the conducting layer and the copper foil, and the flexibility of these electrodes were thus measured. The results are given in the table below.

| | Peel force | |
|---|---|---|
| Electrode | (N/25 mm) | Flexibility |
| Example 11 | 0.5 | 2 |
| Example 12 | 0.5 | 3 |
| Example 13 | 0.35 | 3 |

Because the PVDF was predistributed around the active material filler during the atomization step, the electrode obtained shows greater flexibility for similar values of adhesion between the conducting layer and the copper foil.

The preceding examples can be repeated with similar success by substituting the generically or specifically described reactants and/or operating conditions of this invention for those used in the preceding examples. Also, the preceding specific embodiments are to be construed as merely illustrative, and not limitative of the remainder of the disclosure in any way whatsoever.

The entire disclosure of all applications, patents and publications, cited above and below, and of corresponding French application 01/03.673, are hereby incorporated by reference.

From the foregoing description, one skilled in the art can easily ascertain the essential characteristics of this invention, and without departing from the spirit and scope thereof, can make various changes and modifications of the invention to adapt it to various usages and conditions.

1 Lithium-ion battery element which is chosen from the separator and the electroactive layers and which results from the processing of a microcomposite powder comprising a fluoropolymer in the form of particles between 0.1 and 0.5 μm in size and fillers.

2 Element according to claim 1, in which the fluoropolymer of the microcomposite powder is a PVDF homopolymer or copolymer.

3 Element according to either of the preceding claims, in which the fillers of the microcomposite powder are chosen from silica, lithium metal oxides of the LiMₓO_{y} type (in which M is a metal), graphite, carbon black aggregates, carbon fibres and active carbons.

4 Element according to any one of the preceding claims, in which the microcomposite powder is prepared by (co)atomization either of an aqueous solution containing the fluoropolymer particles between 0.1 and 0.5 μm in size and of an aqueous solution of the fillers or of an aqueous solution containing the fluoropolymer particles between 0.1 and 0.5 μm in size and the fillers.

5 Element according to any one of claims 1 to 3, in which the microcomposite powder is prepared by the flocculation or coagulation of an aqueous solution containing the fluoropolymer particles between 0.1 and 0.5 μm in size and the fillers.

6 Element according to any one of the preceding claims, which is an electroactive layer and in which the proportions are from 2 to 40% of fluoropolymer for 98 to 60% of fillers, respectively.

7 Electroactive layer according to claim 6, in which the fillers are chosen from graphite, carbon black aggregates, carbon fibres and active carbons.

8 Negative electrode consisting of the electroactive layer of claim 7 combined with a copper layer.

9 Electroactive layer according to claim 6, in which the fillers are chosen from lithium metal oxides of the LiMₓO_{y} type (in which M is a metal).

10 Positive electrode consisting of the electroactive layer of claim 9 combined with an aluminium layer.

11 Element according to any one of claims 1 to 5, which is a separator and in which the proportions are from 20 to 80% of fluoropolymer for 80 to 20% of fillers, respectively.

12 Separator according to claim 11, in which the fillers are silica.

13 Lithium-ion battery comprising at least one element chosen from the separator of claim 12, an electroactive layer according to claims 6, 7 or 9, a negative electrode according to claim 8 and a positive electrode according to claim 10.

14 Microcomposite powder which is in the form of silica particles covered completely or partly with fluoropolymer particles having a size of between 0.1 and 0.5 μm.

15 Powder according to claim 14, in which the PVDF particles uniformly cover the silica particles.

16 Powder according to claim 14 or 15, in which the proportions are from 20 to 80% of fluoropolymer for 80 to 20% of silica, respectively.
